(19) United States
(12) Patent Application Publication
(10) Pub. No.: US 2008/0285088 A1
(43) Pub. Date: Nov. 20, 2008

(54) Techniques to manage facsimile communications

(75) Inventors: Paul Tidwell, Sammamish, WA (US); Cliff Didcock, Sammamish, WA (US); Siunie Sutjahjo, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/803,969

(22) Filed: May 16, 2007

(51) Int. Cl. H04N 1/00; H04M 11/00

(52) U.S. Cl. 358/402; 379/93.01

(57) ABSTRACT

Techniques to manage facsimile communications are described. An apparatus may comprise a facsimile device having an assigned access number, and a call terminal having the assigned access number and a facsimile control module, the call terminal to establish a call connection in response to a call request with the access number, and the facsimile control module to detect facsimile information and transfer the call connection from the call terminal to the facsimile device. Other embodiments are described and claimed.

### BACKGROUND

When a user has a facsimile device and a telephone, each device typically has its own direct inbound dialing (DID) telephone number. Having two telephone numbers for a single user increases both costs and administrative overhead. One solution includes assigning a single telephone number for both devices, sometimes referred to as a “Single Number Voice/Fax” service. In this case a user publishes one telephone number and both voice and facsimile calls target that number. If a user answers the telephone for a facsimile call, however, they may end up attempting to talk to a facsimile machine and potentially lose the facsimile call. Although a user may understand how and attempt to manually transfer the call to the facsimile device, the facsimile call may often time out before the transfer is completed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to communications technologies for communicating different types of information. Some embodiments may be particularly directed to techniques to manage facsimile (fax) communications and information. In one embodiment, for example, a call terminal and a facsimile device may share a single access number. The call terminal may receive a call request from another facsimile device to establish a call connection where at least a portion of the call path traverses a packet network. The call terminal may establish the call connection in response to the call request. The call terminal may include a facsimile control module. The facsimile control module may detect facsimile information using a facsimile detection module implemented by the call terminal or another device in the call path such as a gateway device. When the facsimile control module detects the presence of facsimile information communicated over the call connection, the facsimile control module may automatically transfer the call connection from the call terminal to the facsimile device associated with the access number. Consequently, a call terminal may effectively share a single access number with a facsimile device, while reducing or eliminating the need for manual transfers in the event a user receives facsimile calls at the call terminal. Accordingly, a user may experience a decrease in costs and potentially fewer lost facsimile calls, while increasing both user convenience and service.

### BRIEF DESCRIPTION OF THE DRAWINGS

FIG. 1 illustrates one embodiment of a communications system.

FIG. 2 illustrates one embodiment of a logic flow.

FIG. 3 illustrates one embodiment of a first message flow.

FIG. 4 illustrates one embodiment of a second message flow.

FIG. 5 illustrates one embodiment of a computing architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” are not necessarily referring to the same embodiment.

Various embodiments may be directed to techniques to manage facsimile communications. More particularly, some embodiments may be directed to switching techniques to switch a facsimile call received by a call terminal to a facsimile device over a packet network. This may be particularly useful when a voice communications device and a facsimile device share, or are accessed by, a single access number. Examples of access numbers may include without limitation a DID telephone number, a telephone numbering system E.164 number, a telephone number mapping (ENUM) translated number, a telephone number extension, an electronic mail (email) address, an instant messaging (IM) address, a chat room address, a domain name, a domain name server (DNS) address, a network address, an Internet Protocol (IP) address, a Media Access Control (MAC) address, a uniform resource identifier (URI), a universal resource locator (URL), a naming authority pointer (NAPTR) address, a dynamic delegation discovery system (DDDS) address, a registry address, globally unique identifier (GUID), and any other unique identifier.

In various embodiments, the call terminal may receive a call request from another facsimile device to establish a call connection where at least a portion of the call path traverses a packet network. In one embodiment, for example, the call terminal may establish the call connection in response to the call request utilizing various Voice Over Packet (VOP) or Voice Over Internet Protocol (VoIP) technologies (collectively referred to herein as VoIP). This may include, for example, a VoIP or IP gateway device. The call terminal may be implemented with a facsimile control module arranged to detect facsimile information using a facsimile detection module implemented by the call terminal or the VoIP gateway device. When the facsimile control module detects the presence of facsimile information communicated over the call connection, thereby indicating that the incoming call is a facsimile call, the facsimile control module may automatically transfer the call connection from the receiving call terminal to the facsimile device associated with the called number. In some cases, the facsimile control module may need to identify the originally dialed access number when sending or transferring the call to the facsimile device, since the facsimile device may have its own unique identifying access number within the system to permit the transfer. A lookup table (LUT), for example, may be used to associate the published external access number used for the call terminal and the facsimile device with another internal access number for the call terminal and/or facsimile device used by the managing network or network administrator. As a result, a call terminal with a single external access number will be able to receive both voice and fax calls, while obviating the need for manual transfers in the event a user receives facsimile calls at the call terminal. This potentially improves the user interface experienced by minimizing the disruption to the user and speeds up the transfer process.

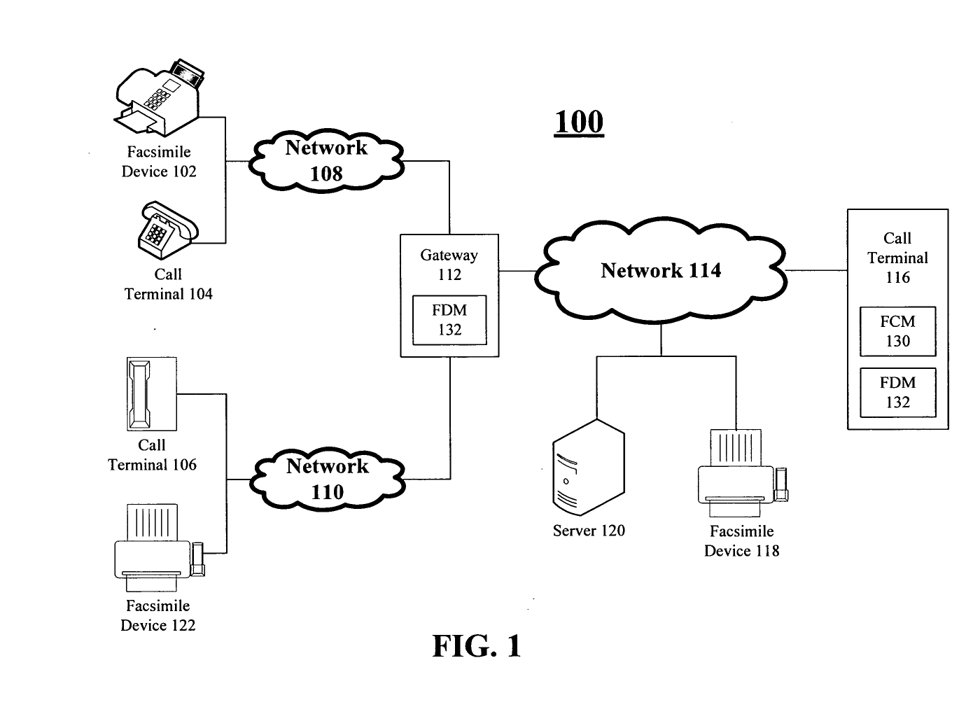

FIG. 1 is a block diagram of a communications system 100. In one embodiment, for example, communications system 100 may comprise multiple nodes. A node may comprise any physical or logical entity for communicating information in the communications system 100 and may be implemented as hardware, software, or any combination thereof, as desired for a given set of design parameters or performance constraints. As shown in FIG. 1, communications system 100 may comprise, for example, various nodes implemented as facsimile devices 102, 118, 122, call terminals 104, 106, 116, a gateway 112, and a server 120, all connected by various networks 108, 110, 114. Although FIG. 1 is shown with a limited number of nodes in a certain topology, it may be appreciated that communications system 100 may include more or less nodes in any type of topology as desired for a given implementation. The embodiments are not limited in this context.

Communications system 100 may be implemented as a wired system, a wireless system, or a combination of both. Although communications system 100 may be illustrated using a particular communications media by way of example, it may be appreciated that the principles and techniques discussed herein may be implemented using any type of communication media and accompanying technology.

When implemented as a wired system, for example, communications system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, communications system 100 may include one or more wireless nodes arranged to communicate information over one or more types of wireless communication media, sometimes referred to herein as wireless shared media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transmitters/receivers (“transceivers”), radios, amplifiers, filters, control logic, and so forth. As used herein, the term “transceiver” may be used in a very general sense to include a transmitter, a receiver, or a combination of both. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

In various embodiments, communications system 100 may include multiple call terminals, such as call terminals 104, 106, 116. Call terminals 104, 106, 116 may each represent any electronic device capable of performing voice communications. Call terminal 104 may represent a voice communication device arranged to communicate voice information over network 108. Network 108 may comprise, for example, a circuit-switched network such as the Public Switched Telephone Network (PSTN). Examples of call terminal 104 may include a telephone, a plain old telephone service (POTS) telephone, a cordless telephone, an analog telephone, a cellular telephone with voice communication capabilities, and so forth. In the case of a cellular telephone, the call terminal 104 may be connected via a cellular radiotelephone network to the network 108. Call terminals 106, 116 may represent a voice communication device arranged to communicate information over network 110. Network 110 may comprise, for example, a packet-switched network, such as the Internet. Examples of call terminals 106, 116 may include a telephone, a digital telephone, a packet telephone, a VoIP telephone, a cellular telephone with data communications capabilities, a computer, a personal computer, a laptop computer, a handheld computer, a mobile computer, a server, a workstation, an appliance, a network appliance, and so forth. In some cases, the call terminals 106, 116 may be connected to the network 110 via a wireless network, including a cellular radiotelephone network such as a Global System for Mobile Communications (GSM) system or a Universal Mobile Telecommunications System (UMTS), a wireless local area network (WLAN) such as an 802.11 network, a wireless metropolitan area network (WMAN) such as an 802.16 network, a wireless wide area network (WWAN) such as an 802.20 network, a personal area network (PAN) such as a Bluetooth network, and so forth.

In one embodiment, for example, communications system 100 may include facsimile devices 104, 118, 122. Facsimile devices 104, 118, 122 may represent any electronic device arranged to communicate facsimile information, such as transferring copies or facsimiles of documents over a network. Facsimile devices 104, 118, 122 typically comprise an image scanner and an inkjet or laser printer combined into a single package. The scanner converts the content printed on a physical document into a digital image, the image data is communicated over a network to another device, and a printer at the far end produces a copy of the transmitted document. Facsimile device 104, for example, may include a modem to send the image data over a phone line to another device over a circuit-switched network such as the network 108. Facsimile devices 118, 122 may include a packet network interface to send the image data over a packet network such as network 110. Some facsimile devices can be connected to, or integrated with, other devices such as computers, printers and photocopiers.

In one embodiment, for example, facsimile device 118 may be implemented as a fax server. In some cases, particularly corporate environments, facsimile devices may be implemented in the form of “fax servers” and other computerized systems capable of receiving and storing incoming faxes electronically, and then routing them to users on paper or via secure email. Such systems have the advantage of reducing costs by eliminating unnecessary printouts, improving security of data and reducing the number of inbound telephone lines needed by an office.

In one embodiment, for example, communications system 100 may include a server 120. Server 120 may be implemented as a unified communications system or unified messaging system. A unified messaging system involves integrating different communications methods and systems. Historically, electronic mail (email) and related data (e.g., calendar, contact, and task data), voice mail, and facsimile traffic have traveled on separate paths through communications networks, and they have been accessible through separate tools, such as computers, telephones, and facsimile machines. A unified messaging system integrates telephony, facsimile, and email services into a single client or application. In one embodiment, for example, server 120 may be implemented as a Microsoft® Exchange Server 2007 implementing Exchange Unified Messaging application software arranged to provide unified messaging technology to give information workers the convenience of their voice, facsimile, and e-mail data delivered into a single mailbox. Exchange Unified Messaging, for example, can record voicemails and faxes and store them in a user inbox along with received email. Similarly, voicemail systems implemented as voice servers or facsimile servers enable users to receive faxes into their voicemail mailboxes. Email facsimile servers operate as e-mail “gateways” and allow users to receive faxes directly into their email mailboxes. It is worthy to note that although FIG. 1 illustrates the facsimile device 118 as separate from the server 120 for purposes of clarity, it may be appreciated that the facsimile device 118 may be integrated with the server 120 and still fall within the scope of the embodiments. In this case, the server 120 may be considered a facsimile device as described and claimed herein. The embodiments are not limited in this context.

In one embodiment, for example, communications system 100 may include a gateway 112. Gateway 112 may operate to provide VoIP services for the call terminal 116, the facsimile device 118 and the server 120. For example, the gateway 112 may perform various call control operations, such as those typically performed by Internet Protocol (IP) private branch exchange (PBX) systems. Examples of such functionality may include protocol translation, address translation, admission control, call control signaling, call authorization, call management, call transfers, call setup, call teardown, call switching, and so forth. Gateway 112 may further comprise interfaces to convert a conventional telephony call to an IP telephony call or VoIP telephone call. For example, gateway 112 may receive time division multiplexed (TDM) or pulse code modulation (PCM) signals from a circuit-switched network, such as the PSTN as represented by the network 108, and convert the circuit-switched signals into packets.

In various embodiments, the gateway 112 may perform packet operations in accordance with a given set of standards or protocols. In one embodiment, for example, the gateway 112 may implement a signaling protocol as defined and promulgated by the Internet Engineering Task Force (IETF) standards organization, such as the Session Initiation Protocol (SIP) as defined by the IETF series RFC 3261, 3265, 3853, 4320 and progeny, revisions and variants. In general, the SIP signaling protocol is an application-layer control and/or signaling protocol for creating, modifying, and terminating sessions with one or more participants. These sessions include IP telephone calls, multimedia distribution, and multimedia conferences.

In one embodiment, for example, the gateway 112 may implement a data format protocol, such as the Real-time Transport Protocol (RTP) as defined by the IETF RFC 3550 and progeny, revisions and variants. The RTP standard defines a uniform or standardized packet format for delivering multimedia information (e.g., audio and video) over a packet network, such as the packet network 114 or the Internet as represented by the network 110.

In one embodiment, for example, the gateway 112 may implement a facsimile protocol, such as the International Telecommunication Union (ITU) T.38 Fax over IP protocol as further defined by the IETF RFC 3362 and progeny, revisions and variants. The T.38 standard defines a uniform or standardized packet format for delivering facsimile information over a packet network, such as the packet network 114 or the Internet as represented by the network 110. For example, the facsimile device 122 may be a T.38 device capable of sending faxes to another T.38 device such as the facsimile device 118. In another example, the facsimile device 102 may comprise a T.30 device capable of sending faxes over the PSTN to the gateway 112. In the latter example, the gateway 112 may operate as a T.38 facsimile gateway which converts or encapsulates the T.30 protocol into T.38 data stream. The gateway 112 may send the T.38 data stream to a T.38 enabled end point such as the facsimile device 118, the unified messaging system or fax server 120, or another T.38 gateway that converts it back to PSTN signals and terminates the fax on another T.30 device. The T.38 recommendation defines the use of both the IETF Transmission Control Protocol (TCP) and the IETF User Datagram Protocol (UDP) to transport T.38 packets. The T.38 standard, however, is not a call setup protocol, and a T.38 device typically needs to be using the same call setup protocols used to negotiate the T.38 call, such as the SIP signaling protocol, for example.

In some cases, the gateway 112 may optionally implement a security protocol such as the Transport Layer Security (TLS) protocol to secure and authenticate communications between the gateway 112 and other devices connected to the network 114. The TLS protocol and its predecessor, the Secure Sockets Layer (SSL) protocol, are cryptographic protocols which provide secure communications on the Internet for such operations as web browsing, email, Internet faxing, instant messaging and other data transfers.

Since the gateway 112 implements various types of protocols (e.g., SIP, RTP, T.38), some or all of the other devices connected to the gateway 112 via the packet network 114 may also implement the same or similar types of protocols. For example, the call terminal 116, the facsimile device 118 and/or the server 120 may each be implemented as a SIP client, a RTP client, and/or a T.38 client, or include appropriate protocol translators or interfaces, in order to properly communicate with the gateway 112.

In general operation, the communications system 100 may be used to implement various techniques to manage facsimile communications communicated using VoIP technologies. In typical scenarios, the call terminal 116 and the facsimile device 118 each has its own access number, such as a DID telephone number. Having two access numbers for a single user, however, increases both costs and administrative overhead. Although a user may attempt to manually transfer the call to the facsimile device, the facsimile call may often time out before the transfer is completed.

Various embodiments attempt to solve these and other problems. In one embodiment, the call terminal 116 and the facsimile device 118 may effectively share a single access number, such as a telephone number or network address. This may be facilitated using a facsimile control module 130. The facsimile control module 130 may detect facsimile information using a facsimile detection module 132 implemented by the call terminal 116 or the gateway 112. When the facsimile control module 132 detects facsimile information (e.g., comfort noise generator tones) communicated over the call connection, the facsimile control module 130 may automatically transfer the call connection from the call terminal 116 to the facsimile device 118 associated with the access number.

Although a single access number for both a call terminal and facsimile device may be externally published thereby appearing if both devices share the same access number, it may be appreciated that the internal network managed and/or serviced by the gateway 112 typically has separate and globally unique identifiers (GUID) to identify one or both devices. For example, the facsimile device 118 and/or server 120 may each have their own GUID separate from the access number used by the call terminal 116. In a SIP system, for example, the GUID may comprise a SIP URI. In this case, the gateway 112 may use the single access number used for both the call terminal 116 and the facsimile device 118 to identify only the call terminal 116, and a different internal GUID to identify the facsimile device 118. This serves several purposes, such as allowing transfer operations to be performed to a given facsimile device, and also to ensure that each facsimile call may be directed to a facsimile device, account or user to ensure differentiated receipt by the intended recipient, rather than just simply sending all facsimile calls to a general pool. To accomplish this, the facsimile control module 130 may need to identify the originally dialed access number prior to sending or transferring the call to the facsimile device 118. The facsimile control module 130 may use the originally dialed access number to search, lookup, find or otherwise retrieve a GUID for the facsimile device 118 since the facsimile device may have its own unique identifying access number within the system to permit the transfer. A LUT, table, list or other data structure, for example, may be used to associate a particular access number used for the call terminal 116 and/or the facsimile device 118 with a GUID for the facsimile device 118. The facsimile control module 130 may then transfer, or coordinate the transfer, of the facsimile call from the call terminal 116 to the facsimile device 118 using the GUID for the facsimile device 118. This may be particularly appropriate if the facsimile device 118 is a facsimile server or unified messaging system server having its own unique SIP URI, for example.

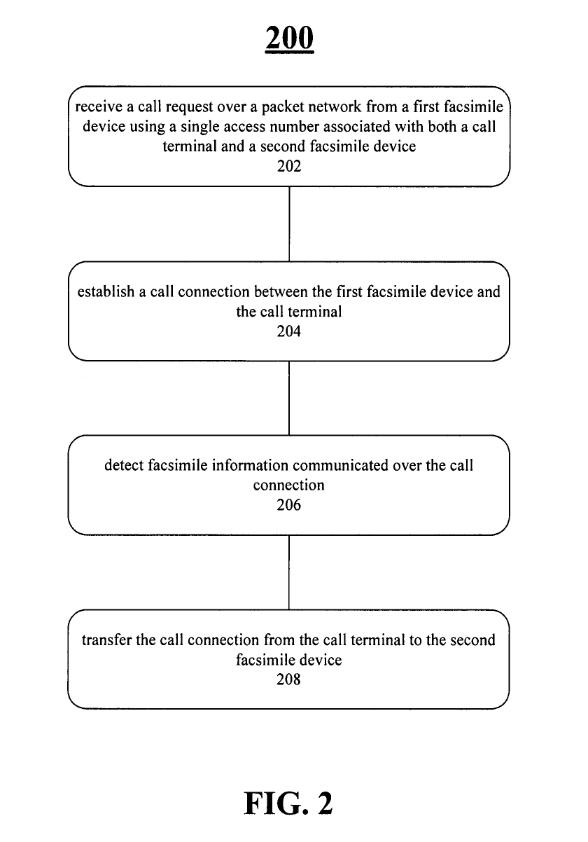

Consequently, the call terminal 116 may effectively share a single access number with the facsimile device 118, while reducing or eliminating the need for manual transfers in the event a user receives facsimile calls at the call terminal 116. Accordingly, a user may experience a decrease in costs and potentially fewer lost facsimile calls, while increasing both user convenience and service. The communications system 110 in general, and the facsimile control module 132 in particular, may be described in more detail with reference to FIGS. 2-5.

Operations for the communications system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints.

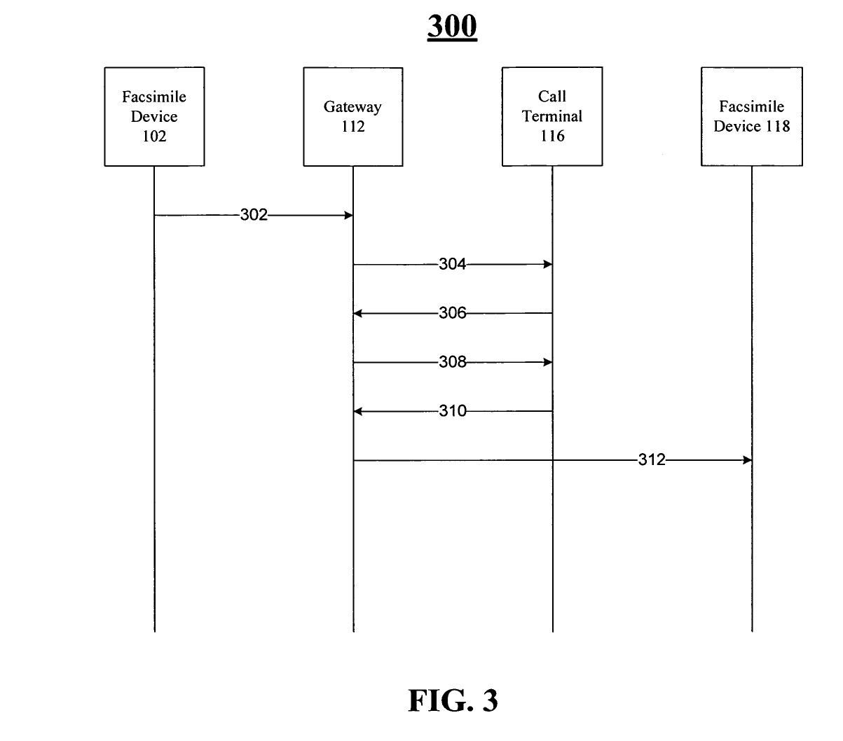

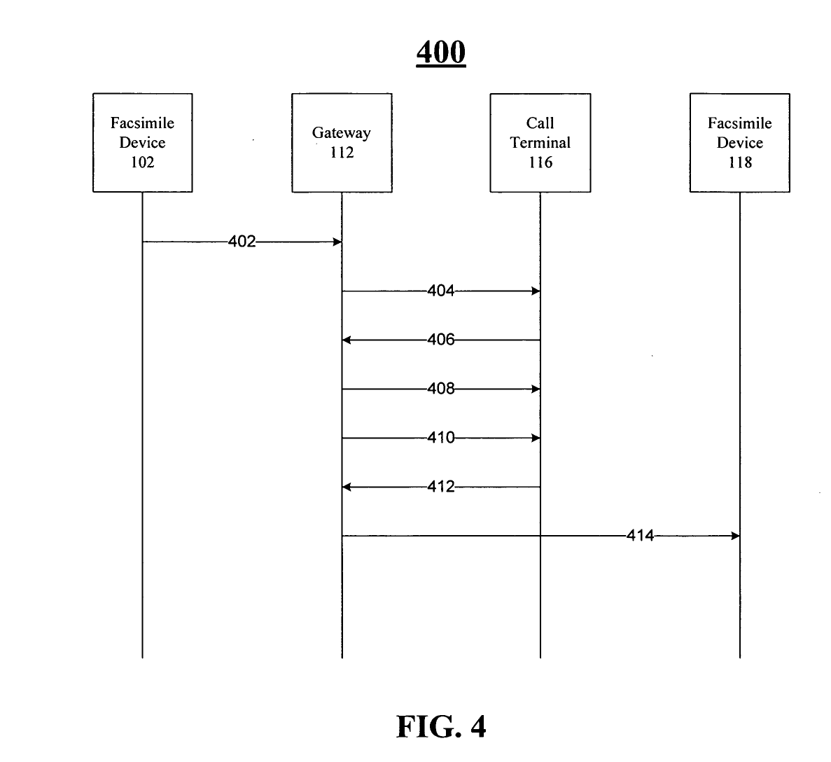

FIG. 2 illustrates a logic flow 200. Logic flow 200 may be representative of the operations executed by one or more embodiments described herein. As shown in FIG. 2, the logic flow 200 may receive a call request over a packet network from a first facsimile device using a single access number associated with both a call terminal and a second facsimile device at block 202. The logic flow 200 may establish a call connection between the first facsimile device and the call terminal at block 204. The logic flow 200 may detect facsimile information communicated over the call connection at block 206. The logic flow 200 may transfer the call connection from the call terminal to the second facsimile device at block 208. The operations of the logic flow 200 may be described in more detail with reference to the message flows of FIGS. 3 and 4.

FIG. 3 illustrates one embodiment of a message flow 300. The message flow 300 illustrates an exemplary message flow between the facsimile device 102, the gateway 112, the call terminal 116 and the facsimile device 118. As previously described with reference to FIG. 2, the logic flow 200 may receive a call request over a packet network from a first facsimile device using a single access number associated with both a call terminal and a second facsimile device at block 202. As shown in FIG. 3, the facsimile device 102 may initiate a call request to establish a call connection with the access number associated with the call terminal 116 and the facsimile device 118 as indicated by a message 302. The facsimile device 102 may initiate the call request to send facsimile information over the established call connection. The call request may traverse the network 108 and arrive at the gateway 112. Gateway 112 may receive the call request, and initiate SIP operations to perform call control operations to establish a call connection with the call terminal 116 or the facsimile device 118 based on a set of default parameters. For example, the gateway 112 may have a lookup table (LUT) to determine whether the call terminal 116 or the facsimile device 118 should be the first device to receive the call request from the facsimile device 102. To avoid voice calls terminating at the facsimile device 118, the gateway 112 may be arranged to send all call requests to the shared access number to the call terminal 116.

Referring again to FIG. 2, the logic flow 200 may establish a call connection between the first facsimile device and the call terminal at block 204. In one embodiment, for example, this may be accomplished using a VoIP protocol, such as the SIP signaling protocol. The gateway 112 may send a SIP INVITE message to the call terminal 116 as indicated by message 304. The message 304 may cause the call terminal 116 to execute an audio (e.g., ringing) or visual indicator for the user to indicate that there is an incoming call request for the call terminal 116. Once the user answers the call request by depressing a call button or lifting a handset, the call terminal 116 may send a SIP 200 OK message to the gateway 112 as indicated by message 306. The gateway 112 may send an ACK message to the call terminal 116 as indicated by the message 308. At this point, a call connection and call session has been established between the facsimile device 102 and the call terminal 116.

Referring again to FIG. 2, the logic flow 200 may detect facsimile information communicated over the call connection at block 206. In one embodiment, for example, facsimile information detection operations may be accomplished at the call terminal 116. For example, the call terminal 116 may include the facsimile detection module 132 to detect facsimile information communicated over the established call connection between the facsimile device 102 and the call terminal 116. The facsimile detection module 132 may generate and output a facsimile detection message to the facsimile control module 130 once the facsimile information has been detected. The facsimile control module 130 may send a SIP REFER message to the gateway device 112 as indicated by the message 310. The SIP REFER message is a SIP message designed to transfer a call connection between the various nodes connected to the network 114. The gateway 112 may receive the SIP REFER message from the call terminal 116, and automatically transfer the call connection from the call terminal 116 to the facsimile device 118 as indicated by message 312. As a result, a user avoids the need to manually transfer the facsimile call to the facsimile device 118, thereby reducing the risk that the facsimile call may time out before the transfer is completed and reducing potential disruptions to the user.

FIG. 4 illustrates one embodiment of a message flow 400. The message flow 400 illustrates an exemplary message flow between the facsimile device 102, the gateway 112, the call terminal 116 and the facsimile device 118. As previously described, facsimile information detection operations may be performed by the call terminal 116. Alternatively, facsimile information detection operations may be performed by the gateway 112. The message flow 400 illustrates an implementation where the facsimile detection module 132 is implemented at the gateway 112.

When the facsimile detection module 132 is implemented by the gateway 112, the operations and message flow for messages 402, 404, 406 and 408 are similar to respective messages 302, 304, 306 and 308. Once a call connection has been established between the facsimile device 102 and the call terminal 116, however, the facsimile detection module 132 of the gateway 112 may detect facsimile information communicated over the call connection. In this case, the facsimile detection module 132 may generate and output a facsimile detection message for the gateway 112. The gateway 112 may send a SIP RE-INVITE message or an RFC 2833 fax tone event to the call terminal 116 to indicate detection of facsimile information as indicated by the message 410. The facsimile control module 130 may receive the SIP RE-INVITE message, and the call terminal 116 may send a SIP REFER message to the gateway device 112 as indicated by the message 412. The gateway 112 may receive the SIP REFER message from the call terminal 116, and automatically transfer the call connection from the call terminal 116 to the facsimile device 118 as indicated by message 414.

In an alternative embodiment, the message flow 400 may use comfort noise generator (CNG) tones to signal the detection of facsimile information by the gateway 112 rather than a SIP RE-INVITE message. The facsimile control module 130 may receive the CNG tones as the message 412, and the call terminal 116 may send a SIP REFER message to the gateway device 112 in response to the CNG tones. The gateway 112 may receive the SIP REFER message from the call terminal 116, and automatically transfer the call connection from the call terminal 116 to the facsimile device 118 as indicated by message 414.

In various alternative embodiments, the gateway 112 may receive a new call request, and initiate SIP operations to perform call control operations to establish a call connection with the server 120 rather than call terminal 116 or the facsimile device 118 based on a set of default parameters. For example, the gateway 112 may use the LUT to determine that all call requests to an access number should be routed to the server 120. Since a computer such as a PC or server may be used to receive inbound calls, it is possible that the gateway 112 may be arranged to send all call requests to the shared access number to a unified messaging system server 120. In this case, if the call request is for facsimile communications, then the server 120 may transfer the call to the facsimile device 118 or another facsimile coder/decoder (codec), or receive and process the facsimile information directly if the server 120 includes facsimile capabilities (e.g., facsimile server operations). The latter case may be more desirable since the server 120 may be operational even when a user's voice communication device or facsimile device is offline or turned off. If the call request is for voice communications, then the server 120 could transfer the call to the call terminal 116 using the SIP REFER message and in doing so ensure that the user is not interrupted by fax calls. It may be more desirable to implement the facsimile switching technology on the call terminal 116, however, since it consumes less resources for the server 120,

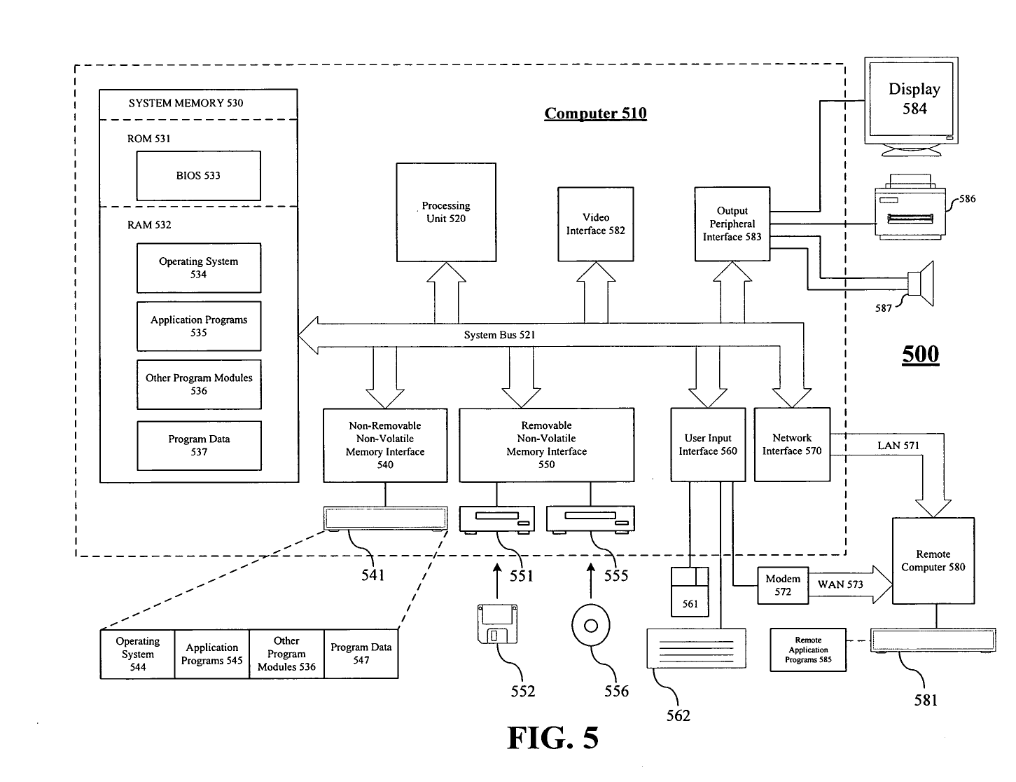

FIG. 5 illustrates a block diagram of a computing system architecture 500 suitable for implementing various embodiments, including the various elements of the communications system 100, such as gateway 108 or call terminal 110, for example. It may be appreciated that the computing system architecture 500 is only one example of a suitable computing environment and is not intended to suggest any limitation as to the scope of use or functionality of the embodiments. Neither should the computing system architecture 500 be interpreted as having any dependency or requirement relating to any one or combination of components illustrated in the exemplary computing system architecture 500.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 5, the computing system architecture 500 includes a general purpose computing device such as a computer 510. The computer 510 may include various components typically found in a computer or processing system. Some illustrative components of computer 510 may include, but are not limited to, a processing unit 520 and a memory unit 530.

In one embodiment, for example, the computer 510 may include one or more processing units 520. A processing unit 520 may comprise any hardware element or software element arranged to process information or data. Some examples of the processing unit 520 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 520 may be implemented as a general purpose processor. Alternatively, the processing unit 520 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 510 may include one or more memory units 530 coupled to the processing unit 520. A memory unit 530 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 510. The embodiments are not limited in this context.

In one embodiment, for example, the computer 510 may include a system bus 521 that couples various system components including the memory unit 530 to the processing unit 520. A system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 510 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 500. Examples of computer readable media for computing system architecture 500 may include, but are not limited to, volatile and/or nonvolatile memory such as ROM 531 and RAM 532. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 530 includes computer storage media in the form of volatile and/or nonvolatile memory such as ROM 531 and RAM 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 540 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 584 or other type of display device is also connected to the system bus 521 via an interface, such as a video interface 582. In addition to the monitor 584, computers may also include other peripheral output devices such as speakers 587 and printer 586, which may be connected through an output peripheral interface 583.

The computer 510 may operate in a networked environment using logical connections to one or more remote computers, such as a remote computer 580. The remote computer 580 may be a personal computer (PC), a server, a router, a network PC, a peer device or other common network node, and typically includes many or all of the elements described above relative to the computer 510, although only a memory storage device 581 has been illustrated in FIG. 5 for clarity. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other technique suitable for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other techniques for establishing a communications link between the computers may be used. Further, the network connections may be implemented as wired or wireless connections. In the latter case, the computing system architecture 500 may be modified with various elements suitable for wireless communications, such as one or more antennas, transmitters, receivers, transceivers, radios, amplifiers, filters, communications interfaces, and other wireless elements. A wireless communications system communicates information or data over a wireless communication medium, such as one or more portions or bands of RF spectrum, for example. The embodiments are not limited in this context.

Some or all of the computing system 100 and/or computing system architecture 500 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a call request over a packet network from a first facsimile device using a single access number associated with both a call terminal and a second facsimile device;
establishing a call connection between the first facsimile device and the call terminal;
detecting facsimile information communicated over the call connection; and
transferring the call connection from the call terminal to the second facsimile device.

2. The method of claim 1, comprising receiving an invite message from a gateway device by the call terminal to establish the call connection.

3. The method of claim 1, comprising detecting facsimile information communicated over the call connection by the call terminal.

4. The method of claim 1, comprising sending a refer message from the call terminal to a gateway device to transfer the call connection from the call terminal to the second facsimile device.

5. The method of claim 1, comprising detecting facsimile information communicated over the call connection by a gateway device.

6. The method of claim 1, comprising sending a re-invite message from a gateway device to the call terminal to indicate detection of facsimile information.

7. The method of claim 1, comprising receiving a re-invite message from a gateway device by the call terminal to indicate detection of facsimile information.

8. The method of claim 1, comprising sending a refer message from the call terminal to a gateway device in response to a re-invite message, the refer message to request a call transfer from the call terminal to the second facsimile device.

9. An article comprising a storage medium containing instructions that if executed enable a system to:
receive a call request over a packet network from a first facsimile device using a single access number associated with both a call terminal and a second facsimile device;
establish a call connection with the call terminal;
detect facsimile information communicated over the call connection; and
transfer the call connection from the call terminal to the second facsimile device.

10. The article of claim 9, further comprising instructions that if executed enable the system to send a call termination message from the call terminal to a gateway device after the transfer.

11. The article of claim 9, further comprising instructions that if executed enable the system to detect facsimile information communicated over the call connection by the call terminal.

12. The article of claim 9, further comprising instructions that if executed enable the system to send a refer message from the call terminal to a gateway device to transfer the call connection from the call terminal to the second facsimile device.

13. The article of claim 9, further comprising instructions that if executed enable the system to detect facsimile information communicated over the call connection by a gateway device.

14. The article of claim 9, further comprising instructions that if executed enable the system to send a refer message from the call terminal to a gateway device in response to a re-invite message, the refer message to request a call transfer from the call terminal to the second facsimile device.

15. The article of claim 9, further comprising instructions that if executed enable the system to transfer the call connection from the call terminal to the second facsimile device in response to a refer message by a gateway device.

16. An apparatus, comprising:
a facsimile device having an assigned access number; and
a call terminal having the assigned access number and a facsimile control module, the call terminal to establish a call connection in response to a call request with the access number, and the facsimile control module to detect facsimile information and transfer the call connection from the call terminal to the facsimile device.

17. The apparatus of claim 16, the facsimile control module having a facsimile detection module to detect the facsimile information and output a facsimile detection message, the facsimile control module to send a refer message to a gateway device to transfer the call connection from the call terminal to the facsimile device in response to the facsimile detection message.

18. The apparatus of claim 16, comprising a gateway device having a facsimile detection module, the facsimile detection module to detect facsimile information communicated over the call connection, and send a re-invite message or CNG tone to the call terminal to indicate detection of facsimile information.

19. The apparatus of claim 16, the facsimile control module to receive a re-invite message from a gateway device to indicate detection of facsimile information, and send a refer message to the gateway device to transfer the call connection from the call terminal to the facsimile device.

20. The apparatus of claim 16, the facsimile device and the call terminal having voice over packet interfaces.
